(19) United States
(12) Patent Application Publication
(10) Pub. No.: US 2021/0142228 A1
(43) Pub. Date: May 13, 2021

(54) VALUE SYSTEMS

(71) Applicant: SHAWN HUTCHINSON, HARPERS FERRY, WV (US)

(72) Inventor: SHAWN HUTCHINSON, HARPERS FERRY, WV (US)

(21) Appl. No.: 16/634,403

(22) PCT Filed: Jul. 27, 2018
(86) PCT No.: PCT/US18/44189

§ 371 Date: Jan. 27, 2020

Related U.S. Application Data
(60) Provisional application No. 62/537,796, filed on Jul. 27, 2017.

(30) Foreign Application Priority Data
Dec. 8, 2017 (US) PCT/US2017/065313
Jan. 26, 2018 (US) PCT/US2018/015401

(51) Int. Cl. G06Q 10/02; G06Q 20/04; G06Q 20/02; G06Q 30/06; G06Q 10/10; G06F 16/9535

(52) U.S. Cl. CPC G06Q 10/02; G06Q 20/047; G06F 16/9535; G06Q 30/0633; G06Q 10/1095; G06Q 20/023

(57) ABSTRACT

Affect and value relations according to pricing and attributes.

### CROSS-REFERENCED APPLICATIONS

This application claims priority to U.S. Provisional Applications 62/537,796 entitled ‘Value Systems,’ 62/432,528 entitled ‘A Unique Pricing Engine,’ and 62/451,520 entitled ‘Secure Authentication and Financial Attributes Services.’ And this application is a Continuation-in-Part of PCT/US18/15,401 application entitled ‘Secure Authentication and Financial Attributes Services’ and of PCT/US17/65,313 application entitled ‘A Unique Pricing Engine.’ The entire contents of these applications are hereby incorporated by reference.

### FIELD OF INTEREST

Value Systems seek to relate logic, reason, affect, value, and interpretation in ways that are numerically relevant. Numerical relevance in this sense encompasses, for example, monetary values as well as numerical representation of quantifiable relations and inequalities such as, for example, spaces, coordinates, values, evaluations, comparison purposes, and their representations in bits and qubits. Values, however, refers to the value in terms of a quantifiable relation as well as to the value in terms of sensible relations or qualifiable relations. Value Systems furthermore expresses either in quantifiable and/or qualifiable terms the relations among terms of logic, reason, affect, value, and interpretation.

Numerous ways of generating customized pricing exist in the marketplace. However, there lacks a method of providing unique pricing for products and services according to the customer. Customized pricing, however, seeks to provide tailored prices for customers according to strategies that are determined by inventory, bulk discounts, supply chain costs, pricing plans, class plans, category plans, pricing tables, and coupons. Such prices may be referred to as customized, personalized, tailored, optimized, intelligent, group, sales, markup, markdown, adjusted, discounted, dynamic, and/or prioritized pricing. In contrast, unique pricing provide prices for products and services that are unique to the customer.

### STATE OF THE ART

Existing measures to related logic and reason to value are often ascribed to formal systems and to some extent probabilitistic models. First order and second order relations of cause, effect, and their associations are conventionally implemented to determine roles and relations among reason and their values. And while historically the sense of the terms ‘springs of action’ and ‘human motivation’ are retained in reasoned and emotive domains, the complexity of human action appertains to additional terms that may be obfuscated from the analyses in terms of formalities and probabilities. The analyses that approach deterministic systems among them are furthermore limited by the terms used to account articulate, characterize, describe, and explain. And so, philosophical and numerical procedures that are implemented to determine them are hindered by the terms and concepts used to convey the logic, meaning, and value of affect and reason as well as interpretations thereamong and therebetween.

Another way to refer to existing conundrums that vex attempts to relate human action to purely deterministic probabilities and materialistic formalities, for example, are to point to the analytical systems used to explain them. For example, formal systems are often relying on the structures of thought that are implemented in order to articulate them. Namely, one the one hand, are hierarchical structures such as the measured analytics, metrical comparisons, Linnaean classification, whole-part, and metaphysical relationships. And on the other, discursive and dispositive procedures for relating truth, emotion, feeling, meaning, value, and through communicative and expressive relationships. The procedures rely on forms of logic and justification that are indeterminate and insensitive with regards to parameters that are undisclosed according to the terms of their relational system.

Moreover, formal systems are often limited to what is known by them, and discovering what is not known is rather problematic for systems that rely on rote formalities and probabilities to describe and relate systems of human logic, reason, affect, and value. An intelligent human observer who does not know that s/he is color blind is unaware that they cannot observe the color red or the color green, as the case may be. Such a person requires another device to filter red or green color in order to see a tinted contrast and to recognize a difference in two colors that is otherwise readily visible to an unassisted intelligent observer. To the observer who cannot see red or green, the names for colors used to describe the colors that the person sees probably does reflect what s/he is able to see but does not describe the factual reality of a normal view that is otherwise imperceptible to her/him without a visual assistance device. A person therefore does not know the specific terms that s/he does not know.

While procedures for referring to formalistic and probabilistic systems are able to, in a limited extent, refer generally to things that are not known, the purpose of Value Systems is to define ways for ascertaining the specifics of things that are unknown and unknowable without another device. Some existing ways that generally such things are referred to are in terms of fuzzy logic, membership functions, game theory, chicken-and-egg, prisoner dilemma, traveling salesman, etc. Other ways may refer to constrain-unconstrained, completeness-incompleteness, certainty-uncertainty, and other kinds of dichotomies that do their best to account for observations about complex systems. Further ways to point to the properties of systems in one way or another with reference to so-called ‘hidden variables’ or to deep systems as subordinate experience, ego, libido, subconsciousness, etc. Value Systems is thus directed towards explicating comprehensively complex systems.

We are interested here in providing the computational structure that allows for complex terms that govern relations among logic, reason, affect, value, and interpretation to be explicated in quantifiable and qualifiable ways. Quantifiable ways may be numbers, colors, prices, data, and structures. Qualifiable ways may be affective, emotive, sense, sensibility, and feeling. Interpretation therefore appertains to the determinacy among and between terms that are at least to a partial extent quantifiable and at least to a partial extent qualifiable. Generally speaking human and artificial systems encompass such relations. Interpretation relates to the ways that the qualifiable and quantifiable are expressed and represented through relations among them. The purpose of Value Systems is to determine and discover the ways that these terms are related. Interpretation therefore relates to means of relating the meaning of one communicative system to another, and therefore further encompasses for example expression, translation, transcribing, converting, and exchanging.

### SUMMARY

Value Systems determines ways of quantifying as well as interpreting among and between quantifiable and qualifiable attributes, properties, and states. One of the most useful examples of doing so—to interpret from logic and reason to affect and value, and vice versa—is to implement systems that numerical ascribe states to each. The present invention is directed towards clarifying systems that are ambiguous, fuzzy, undescribed, indeterminate, and/or partially comprehended. Another way of setting forth the use of value system is an interpretive adapter among and between logical systems, such as essentialism—existentialism, reason—experience, and absolutism-perspectivalism. The systems herein contain a set of useful sources in accomplishing the procedures required to obtain these results, as well as detailed disclosure of a system that is useful in producing such results in terms of monetary values. The aim of Value Systems is in other words, at least in part, and goal is to resolve the unknown.

Statistical, probabilistic, inferential, interpolative, and extrapolative processes may be useful in determining associations and correlations among and between data points including, for example, causation, steps, translations, sets, and sequencing in terms of time as well as cause-effect. Examples and embodiments contained herein shall not be construed as a limitation, either implicit or explicit.

The following explanation of figures exemplifies embodiments of further preferred and illustrative devices, interfaces, methods, and systems for secure authentication of identifying data and financial attributes services. The following embodiments are meant for illustrative purposes and not to limit the span or breadth of the envisioned inventions.

### LIST OF FIGURES

FIG. 1. Aggregate Rules for Donations

FIG. 2. Attribute Addresses.

FIG. 3. Search Flow.

FIG. 4. Schedule Flow With Pricing Engine.

FIG. 5. Pricing Engine Data Attributes.

FIG. 6. Payment Assembler Rover Flowchart.

FIG. 7. Assembler Payment.

FIG. 8. Donations Flow.

FIG. 9. Search Interface.

FIG. 10. Database Relationships

### DISCUSSION

Data Sets show the relation among prices according to personal attributes that are interpreted through Resource Buffers. A representation of a digest. Prices are displayed according to these, as well as selections that a person (member) makes in terms of the amounts they wish to donate as well as in terms of the prices that they are shown according to the Member Index. Set Price in Amount Per Participant shows the way that parts of the price are determined according to the participation rate. Participation rate follows logic according to the country that a Provider comes from as well as the country that a Member comes from. Interpreting a digest of value and affect in order to display search data to a Member in a rapid sequence.

Member Indexes are determined according to Verified Income Data that corresponds with a Member's financial data. The weight given to personal data that the Member provides. The tabulations of counts according to worth are used in determining a raw index weight before the member index is further adjusted according to the results of the Verify Financial Information process. The personal attributes that a Member selects from among. The response to the fields are used in determining the Member Index as discussed herein.

Various combinations of price displays for the Member according to the financial attributes and other personal data. The form process for the Member to input data corresponding with financial information. This data is used to determine the Member Index on account of the Member Index Calculations. Ethnicities that Members specific about themselves. Responses to one or more of these fields effects the Member Index and the price that the Member is shown for a bookable price. Denominations that Members specific about themselves. Responses to one or more of these fields effects the Member Index and the price that the Member is shown for a bookable price. Member Sample Data that shows Member's attribute data.

Aggregate Rules for Donations. Logical Rules and options are provided for a person to make a financial contribution that is selected to be presented to the Member at the time of booking. Programmatic Rules and functional properties for the determination of Resource Buffers. Sales Tax rates used to calculate the amount of sales tax calculated according to a Member or Provider bookings. Data and information that is displayed to one or more Members and Providers. The websites that display Member and Provider Profile information, and where bookings are made and payments collected.

### Preferred Embodiments

An application for scheduling, managing services and calculating unique price for booking. Public users can search for services, view services, view service providers profile and their reviews. They can also register to become a member or service provider. Members can search for services, book the service, send emails to service provider, view all booked services, cancel the service and view/update their profile information. Service Providers can search, view own services, add new service, create availability, view all bookings, view member profile, view own profile and reviews. Admins can view/update member profile, view/update service provider profile, view booked services, view payment transaction, transfer amount and view cancellation report.

FIG. 1. Aggregate Rules for Donations. Logical Rules and options are provided for a person to make a financial contribution that is selected to be presented to the Member at the time of booking.

FIG. 2. Attribute Addresses. Addresses that are assigned to each of the personal attributes. The addresses are used to efficiently refer to data that correspond with a Member and to Aggregate Buffer. Addresses of attributes are useful in the process of compiling digests of values and numerical states. Digests are further useful in preprocessing data for rapid display and quick sorting.

FIG. 3. Search Flow. Flowchart that shows the search and display platform that serves a plurality of websites as well as Members and Providers.

FIG. 4. Schedule Flow With Pricing Engine. Flowchart that shows the possible displays of prices according to the data that the Member providers in terms of personal attributes. One Flowchart.

FIG. 5. Pricing Engine Data Attributes. Addressable attributes that are useful in numerical interpretation of affect and value.

FIG. 6. Payment Assembler Rover Flowchart. A procedure for bundling payments wherein one or more sources of funds are assembled and then bundled into a sum for a purchase transaction.

FIG. 7. Assembler Payment. A procedure of a payment assembler as a payment is bundled.

FIG. 8. Donations Flow. A procedure for a Member to make rules according to affect and value for the Aggregate Buffer. Rules are addressable. Rules are useful for assembling payments to bundle.

FIG. 9. Search Interface. A search interface to displays interpretive data in combination according to one or more addressable attributes and values.

FIG. 10. Database Relationships.

### Appendix 1. A Unique Pricing Engine

A Unique Pricing Engine generates pricing for a product or service according to customer-specific information that is used to calculate a unique price. Furthermore, manufacturers, merchants, wholesalers, producers, retailers, and suppliers may also provide unique prices that provide their products and services a competitive advantage. Namely, a provision of cost buffering allows the unique price that a customer pay to be lower than a price competitor. The unique pricing engine may hold a cost buffering resource that subsidizes prices for customers. Furthermore, the cost buffering resource is supplied with resources that may be monetized and reduce the price that customers pay. Such resources that supply cost buffering include, and are not limited to, automated bartered goods and services, optional price overrides for customers who select performance pricing strategies, credit systems that count sales towards rewards, volumetric cost derivatives, as well as through direct monetary contributions. The resource buffering resource allows the engine to set pricing points that are generated according to desired ranges for a merchant service. The unique price presented to a customer may be higher or lower than a customized price.

In preferred embodiments, the unique pricing engine generates a price for a product or service that is unique for the customer of that product or service. The price offered to the customer is calculated according to parameters set by both the manufacturers, merchants, wholesalers, producers, retailers, and suppliers as well as the customer. The parameters that a customer sets include, for example, cost of living, standards of living, local standards, aggregate standards, family status, marital status, education level, amount of time, time of day, availability, per diem, income level, tax bracket, ZIP code, extended ZIP, volume of transactions, profit margin, and a charitable giving option. Parameters may also be set on behalf of the customer, and vice versa. In some cases the provider of a product or servicer may also set identical or similar parameters. A customer could be an individual, collective, coop, group, or a legal entity such as a corporation. The parameters that an entity customer or provider sets include, for example, actuarial metrics, customer analytics, market discounts, tariffs, surges tax credits, tax strategies, investment strategies, numbers of transactions, pricing agreements, inventory, supply, demand, transaction costs, advertisement analytics, performance analytics, click metrics, and so on.

The unique pricing engine allows the manufacturers, merchants, wholesalers, producers, retailers, and suppliers to set their own costs. The aforementioned systems for determining such pricing—customized, personalized, tailored, optimized, markup, markdown, adjusted, discounted, dynamic, and/or prioritized pricing—may provide their settings. While the unique pricing that is generated by the engine may also be factored into the pricing systems. The purpose of the unique pricing engine is to provide competitive advantages to both the customer and to the manufacturers, merchants, wholesalers, producers, retailers, and suppliers. The benefits of the engine include increased revenue, marketing incentives, brand recognition, improvements for the social good, and strategic development of branding.

A Unique Pricing Engine can preferably be configured through a graphical user interface that allows a customer to set the factors that are used to generate the unique price. A customer creates an account and registers their personal identity information. The interface provides input fields for the customer to specify information that is public, sensitive, and/or private. For example, the customer inputs the name, age, marital status, number of children, tax bracket, taxable income, education level, and zip code. The engine gathers personal, quantified, and statistical information related to the customer, the neighborhood, city, and state. More detailed information may also be provided according to tax transcripts, liens, debt accounts, credit report, credit score, driver's license, insurance history, background check, behavioral metrics, click history, and other data metrics that allow a customer's context, resources, identity, and habits to be articulated in parametric form. These detailed data about a customer are used to calibrate the purchase capacity of a customer for a given product.

In a preferred embodiment, a user registers at a digital interface to the Unique Pricing Engine and provides data in the input fields. Parameters are used to determine a variable pricing index. An index is generated with the data from the input fields. For example, a customer having a large family with an income that is on par with the national average may have an index greater than a set pricing threshold. A set pricing threshold may be a simple price of good sold before fees are calculated for taxes, shipping, handling, and/or connectivity fees. A set pricing threshold may be used to allow a customer or a provider to request a price engine alteration, to set a price limit, redisplay prices with or without fees, price bidding, peer group combined purchasing, collective purchasing, bulk discounting, surge pricing, increase/decrease gift levels, and priority purchase positions. A customer index then may be used to reduce the price of a product. Another customer may have an income higher than the national average and have fewer dependents. In this case the customer index increases the price paid for a product. The price paid could be higher or lower than a benchmark price that a provider sets. The resource buffer account may be debited or credited according to the price paid for a product or service by a customer. A customer's input factors are used to calculated a weight, coefficient, variable, or numerical factor to the pricing index according to a customer's purchasing capacity, local standards affordability, risk factor, and customer history. Furthermore, a pricing index could be generated according to aggregate standards, socio-economic statistics, demographics, housing metrics, or other impersonal sources of data that may be used to further resolve or float the unique price that a customer pays for a product or service.

A customer pricing index may be a multiplicative coefficient or denominator value that allows the product price to be determined according to the unique personal identity information. The numerical value of the data input into these fields may increase or decrease a variable pricing index. The engine may implement multiple pricing indices for a customer according to the cost of a product. These data inputs may be stored in an account, on a portable data device, a chip card, a magnetic strip card, or may be inputted on demand. The data may be stored and accessed when needed, only one time, or used a set number of times.

A provider such as a manufacturers, merchants, wholesalers, producers, retailers, seller, suppliers, or servicer registers data inputs relating to the price of a product or service. The data could be a benchmark price of a product. The pricing data may also be a price determined according to aforementioned methods and systems that calculate prices according to customized, personalized, tailored, optimized, markup, markdown, adjusted, discounted, dynamic, and/or prioritized pricing. A benchmark price may be determined according to inventory, bulk discounts, supply chain costs, and pricing plans. Moreover, a provider may input similar or identical information that a customer provides in order to determine a provider pricing index. A provider pricing index may be specific for an individual or entity. The pricing index may be increased or decreased according to the provider's selling capacity, local standards affordability, advertising, sales and marketing, incentives, risk factor, and sales history.

For servicers, the provider pricing index allows individuals and entities to increase or decrease a price for a product or service according to name, age, marital status, number of children, tax bracket, taxable income, education level, and zip code. More detailed information may also be provided according to tax transcripts, liens, debt accounts, credit report, credit score, driver's license, insurance history, background check, behavioral metrics, click history, and other data metrics that allow a provider's context, resources, identity, and habits to be articulated in parametric form.

A provider pricing index may be a multiplicative coefficient or denominator value that allows the product price to be determined according to the unique personal identity information. The numerical value of the data input into these fields may increase or decrease a variable pricing index. The engine may implement multiple pricing indices for a provider according to the cost of a product. These data inputs may be stored in an account, on a portable data device, a chip card, a magnetic strip card, or may be inputted on demand. The data may be stored and accessed when needed, only one time, or used a set number of times.

The Unique Pricing Engine may be accessed through a graphical user interface on a third-party website, through an Application Protocol Interface (API) that integrates the functionality into an existing website, through a back-end calculation system that generates customized pricing, or through a portable payment device for use at a point of sale system or as a point of purchase system. A point of purchase system processes sales on behalf of a seller to one or more seller, manufacturer, merchant, wholesaler, producer, retailer, and supplier. Such portable payment device, purchase card, or point of purchase device may furthermore include a smartphone, credit card, push-button payment system, or click channel that performs, initiates, connects, or completes a transaction for a sale, order, refund, automated clearinghouse, or any such merchant transaction. In another preferred embodiment, the Unique Pricing Engine is a calculation layer called by an API that may be instantiated at any point or points in the purchase-sale transaction sequence starting from raw materials and completing in product delivery. The Unique Pricing Engine may also preferably be a calculation layer called by an API that may be instantiated at any point or points in the purchase-service transaction sequence starting from initiation of service request and completing of service rendering.

The Unique Pricing Engine may be implemented in such a way that the resource buffer is held for specific individuals, entities, or common amongst individuals and/or entities. For example, a large seller of products may instantiate one or more resource buffers in order to distribute funds from the same of one product category or another. A larger seller could increase prices according to market demand in order to offset costs in other product or service areas. Rather than providing access to resources that could be used as coupons, by comparison, the resource buffer may be available to customers who meet certain parametric criterion. The parametric criterion in this case may be the personal set of financial information such as for example taxable income, standard of living, cost of living, and family status. One of the uses of the engine would be to subsidize the cost of staples that a customer might otherwise not be able to afford. Staple products could be easily be subsidized such as paper products, disposables, comestibles, commodity, and sundry items. A large seller or products could supply resources to a buffer from a manufacturer, internal purchase incentives, through government subsidies, as well as through direct contributions from other customers.

A resource buffer may be implemented with a standard banking accounting system, automated clearinghouse, point of sale system, user interface, and/or a banking API. The resource buffer may be held within a user interface of the Unique Pricing Engine, accessible through it, or external to it. A number of buffers may be used for various products or services, at the discretion of the provider or customer. The resource buffer may also be implemented by the customer in order to budget expenditures. The resource buffer may be implemented to provide parental and guardian controls, supplying of allowance resources, and tracking of expenses and/or purchases.

The supply and demand placed on a resource buffer for resources could be supplied from purchases of durable goods as well as titled and deeded assets. A nonprofit, municipality, religious organization, and/or governmental agency could organize a fund that is used for customers of specific zip codes and demographics in order to subsidize specific product purchases or services. Products need not be limited to staples and commodities. A for-profit organization could give a portion from their revenue towards a resource buffer from profits, advertisement revenue, earnings, and investment income. In an exemplary embodiment, retailers can integrate a unique pricing engine into their point of sale system, implement the Unique Pricing Engine as a point of purchase system, implement a cloud system for access to the Unique Pricing Engine, and/or implement a portable purchase device that generates unique prices for products and services at checkout. Rather than paying averaged retails prices for products, the Unique Pricing Engine in this preferred embodiment generates prices for each product that is purchased according to the resources of the customer. Organizations who offer a resource buffer would find advantages that are useful in attracting customers to a retail site, website, or through brand recognition, for their practice of providing support for customers whose resources are to varying degrees limited. The implementation of a Unique Pricing Engine could improve the click conversion ratio. Similarly, manufacturers, merchants, wholesalers, producers, and suppliers could implement an engine and/or buffer. Service providers could implement an engine and/or buffer for social services, internet services, cable services, delivery services, transportation services, subscriptions, insurance services, mental health services, physical health services, housing services, and health services in general.

In another preferred embodiment, the Unique Pricing Engine may be used to provide unique prices to customers according to an aggregate, a gauged, predicted, forecasted, behavioral, or set parameters. In a preferred embodiment, a seller of products provides an option to a customer to purchase at a price point higher than the average or customized price. Customers may have personal incentives to contribute in an altruistic or charitable manner to the benefits of others. A seller of products could create funds that are collected for altruistic price overrides wherein customers pay a top marginal price offset that is made available in the resource buffer for customers who may not otherwise purchase a product or as much of a product. A seller of products could create a charitable fund that collects donations and gifts on behalf of persons with restricted resources to include those of impoverished means, fixed income, limited income, disability, autistic, or other disposition that renders a person unable to earn or produce at a level that supports their well-being. Similarly, a service organization may also utilize a resource buffer in order to collect resources, distribute, redistribute, and/or subsidize the cost of services according to customer settings.

A preferred digital system embodiments of the Unique Pricing Engine also include a portable payment device that either holds in a data card having the input data from the customer, a pricing index, and/or connectivity to the a server or cloud system. The device may be a smart phone, credit card, chip card, or mobile point of sale device. A payment device may also have a resource buffer. A point of sale device may link to a server or inventory system that contains itemized records for goods or products. The point of sale device communicates with the portable payment device in order to generate unique prices for the products purchased. The point of sale device communicates with the Unique Pricing Engine through a computer, server, or cloud system in order to calculate a unique price or prices. The engine may be implemented as an automated clearinghouse that reconciles accounts with the payment for products sold and the resource buffer. The engine may communicate with a batch processing system in order to reconcile accounts for products sold and the resource buffer. The Unique Pricing Engine may comprise an account number and routing number for use with banking and/or credit card systems. A cloud system may host or communicate through an API with the Unique Pricing Engine, one or more resource buffers, a virtual point of sale system, the portable payment device, and merchant payment accounts.

A digital system may also be implemented for services as well as combinations of products and services. For example a Resource Card or a Reference Card may be used by the customer rather than a Credit Card in order to pay for services. A resource buffer or buffers may be linked with the card in order to determine unique prices for services. The buffer could be linked to insurance cost matrices, look-up tables, actuarial calculations, plan coverages, and the like that calculate reductions in prices according to insurance package. The buffer could be linked to a Health Savings Account in order for account for costs covered by insurance or that are tax deductible and those that are not. The Unique Pricing Engine in this case serves as an intermediary between the customer, the insurance plan/company, as well as the service provider in order to determine costs, process transactions, as well as to credit and debit resource accounts accordingly. The digital system could be communicative with an Application Programming Interface to a credit transaction system in order to process payments from one or more accounts and/or resource buffers. A user interface could be accessible to the customer in order to track purchases, accounting, tax deductions, credit/debit their resource buffer/s. An insurance company may be a private company or a public government organization such as Medicare, Medicaid, or Social Security. The insurance company may provide resources in a buffer from third-party sources, government funding, gifts, loyalty points, incentives, cash rewards, etc. The resource buffer could be used as in incentive for insurance companies to reward customers for maintaining good health or good performance records. A resource buffer could be linked with biometrics and health maintenance programs. Performance records could be linked with health, driving, auto insurance, home owners insurance, and bundled services. Unique Pricing Engine interfaces between one or more insurance, provider agencies, customers, servicers, providers, parents, and dependents.

A merchant preferred embodiment allows a seller to expand the audience of customers, incentive structures, advertising revenue, and the programs designed to assist customers. The seller implements a digital system as defined above. A web portal allows the seller to offer unique prices to the customer for each and every product or service offered. The customer may input settings into their seller account for a Unique Pricing Engine. The seller may link the customer account to a central Unique Pricing Engine interface. The seller may implement one or more resource buffers. Resource buffers may be opened according to product family, brand, category, manufacturer, or supplier. Resource buffers may be opened for advertising purposes wherein resources are paid or given for a product in order to generate a unique price that is specific for each customer. The customer pricing index may be useful in order to fine-tune the amount from a resource buffer provided to subside the purchase prices of a product or service.

The customer pricing index may be useful in order to offset the price higher than the benchmark price in order to collect top margins from product purchases used to subsidize purchases by specific customers according to their pricing input settings. The seller may automate provision of a resource buffer according to purchase history, volume pricing, click analytics, navigation cookies, advertising resources, sales, and incentive programs. The Unique Pricing Engine provides an attractor for customers to see their unique price. The Unique Pricing Engine provides a service that is advantageous for sales and marketing for the common good, charitable purposes, and/or human good. A seller may utilize one or more tax-deductible, charitable giving, contributions from third-parties, and income revenue sources for resource buffers. The seller may develop provider pricing indices according to desired thresholds and levels of pricing points. The seller may develop customer pricing indices according to desired thresholds and levels of pricing points. The seller and the product representative may develop special indices for partnerships, seasonal sales, incentives, volume derivatives, and/or package bundles. The seller may provide incentives for streamlined production, integrated supply chains, favorable status, country of origin, trade standards, manufacturing standards, and production metrics towards pricing indices and resource buffers. The seller develops brand recognition and public trust for use of the engine, buffers, and indices.

A Unique Pricing Engine receives inputs from customer and a product provider such as a seller. Pricing indexes are determined for the customer and seller according to the inputs. Resource buffers for one or more of the customer and seller comprise monetary resources that buffer the difference between the seller price and the unique price paid by the customer. A Unique Pricing Engine determines unique prices for one or more products using the one or more resource buffers. The unique prices are displayed to the customer. Unique prices could be greater than or less than the provider set prices. A product purchase transaction is processed for the customer according to the unique price for one or more products. After one or more products are purchased by the customer, the resource buffers are then credited and/or debited accordingly.

Graphical User Interfaces. Exemplary Graphical User Interfaces are for customer, servicer, and provider inputs. Inputs are used to determine pricing indexes for a customer, service, and/or provider. Inputs may include one or more the following, as well as other quantified parameters that distinguish the uniqueness of a customer, provider, and/or servicer.

A Digital System implements a Unique Pricing Engine. A customer has as shopping cart comprising items for purchase. A purchase card is presented to a point of sale system for purchase. Alternatively a sales card is presented to a point of purchase system for selling one or more products to one or more seller, manufacturer, merchant, wholesaler, producer, retailer, and supplier. The point of sale device decisions with regards to the use of the card, sends the product SKU and customer identifier a cloud implemented Unique Pricing Engine. The Engine responds with a list of unique prices according to one or more pricing indices and/or thresholds. A product purchase transaction is processed for the customer according to the unique price for one or more products. After one or more products are purchased by the customer, the resource buffers are then credited and/or debited accordingly.

Aa standard merchant seller website and a merchant seller implements a Unique Pricing Engine. The standard seller website displays prices according to a standard price, such as a national standard price for a product and/or a service purchase in the United States. Customers select products for purchase, has tax and shipping fees added, and proceeds to a point of sale system for purchase. A merchant seller implementing a Unique Pricing Engine Application Programming Interface (API) provides a customer login. After logging into the seller website, the Unique Pricing Engine supplies customer index and resource buffer data to the website in order to determine unique prices for one or more products to the customer. Alternatively, the seller website may provide product SKU numbers and pricing information to a Pricing Engine and receive unique prices for one or more products and/or one or more services. A customer selects one or more products and/or one or more services for purchase. A product purchase transaction is processed for the customer according to the unique price for one or more products. After one or more products are purchased by the customer, the resource buffers are then credited and/or debited accordingly.

### Appendix 2. Financial Attribute Services

A secure authentication of identity commences first with receiving an identification number for a person or entity. An identification number or record is stored in a data memory. An identification number for a customer may be a Social Security Number. An identification number for an entity may be an Employer Identification Number. A data memory may be in the format of a solidstate device, or it may be a device that is on a network such as the internet, an intranet, extranet, deepnet, and/or a cloud. The identification record is held in memory that is accessible to a processor. The processor is able to make at least basic operations such as comparisons and computations. The processor interfaces with the data memory in order to retrieve at least a portion of the identification record such as a number.

For each unique identification number, a record also has stored a reference number that a consumer uses to reference an identity record. The identification number in this example may be a Social Security Number. While a reference number comprises a portion that the consumer may use for applications and forms rather than the Social Security Number. The reference number may comprise a static and/or dynamic portion. The reference number may mask or encrypt the identification number. The data record comprises at least equivalent identifying features of the identity of a person.

The processor receives a reference number for the purposes of authenticating the identity of a consumer. The processor also receives identifying information about the person's identity. The identifying information may comprise information that is public and/or private. The identifying information may accompany the authentication request at the time of receipt, or according to a desired time differential. Public identifying information may include an address, telephone number, or any kind of information that is available on a public record. Private identifying information may include identifying features that are known privately by the consumer, such as biographical details, taxable income, and/or personal information. The identifying information may also include a private verification protocol through a telephone number, text message, finger print, or other unique referencing identifiers or authentication protocols.

The consumer has the ability to control access to the identifying number with the desired methods of providing an accompanying identifying information. The consumer may provide settings for the availability of accessing the identifying number for the purposes of authentication. Settings may include number of accesses, time of access, address of location, entity permissions, rendezvous timing, recurring access, and/or desirable rules that customize the level of security of the identifying number for consumer. The consumer may be notified of a request for authentication through a digital interface, such as through a telephonic prompt, sms text, electronic mail, voice mail, or other alert or notification of a request to access private identity information.

The processor receives public and/or private identifying information from the consumer and/or a third party. The consumer provides the identifying information to the processor and/or data record. The consumer provides the identifying information from an interface that has connectivity through an internet, intranet, extranet, cloud, solid memory, chip, a physical input at a node, or a method of input that is non-electronic. Identifying information may be held in the data record with the identification number and reference number or may be held in another port of memory that is accessible to the processor or that the processor receives data from. The size of such memory may be from a bit or less, a chip card, an identification card, to macromemory devices such as a drive, shared resources, or to networked resourced such as a cloud. Information may be recorded and/or stored in any manner that allows a processor to receive the information or to request the information when queried to authenticate the identity of a consumer. Transmission of data to, from, with, accompanying, and between the processor and memory may be conducted in any desired protocol such as a secure channel, private-key encryption, integrated circuit, as well as non-electronic transmissions.

The processor receives public and/or private identifying information for a consumer from a third party. The third party supplies the information or requests the information on behalf of the consumer. The consumer may provide a consent or an authorization for the authentication of identifying. The consumer may provide a static or dynamic reference code in order to authorize the authentication. The consumer may provide rules or settings in order to control access to the authentication protocol. The authentication may require input from the consumer in order to complete the authentication request. The processor receives or retrieves the components of the authentication request from the consumer and the third party. The processor then performs a process of authenticating the consumer's identity according to the data provided. The processor may be a crypto, secure, private, distributed, quantum, parcel, mapping, deconvoluting, or encrypted processor.

The third party may, for example, provide a physical address, telephonic address, name, and Zip code of the consumer. The consumer may be notified that the third party is requesting authentication. The processor retrieves data from one or more memory records with the identifying data, or has data supplied to it. Authentication of the identity is accomplished with data check, verification, deconvolution, or any practice of comparing the validity of and/or matching the value of data. The processor responds to a request to authenticate identity with binary response such as yes/no as well as a condition, status, request, bit, code, number, and/or provision of data. Responses may furthermore elicit additional requests and transmission of data.

The response of the processor to the authentication request provides a method for the system to respond to the authentication of a consumer identity in a multi-valent manner. Multi-valent responses allows the authentication to respond with confirmation of an identity, as well as more complex responses. Examples of the multi-valent responses that are complex encompass the likes of provisional authentication, authentication with indication, authentication with request, and/or a negatived authentication with one or more error codes. Error codes could indicate the kind of mismatch of data, missing data, suspicious data, and proprietary indicia. Furthermore, authentication responses, or their negatives, may additional accompany a payment increment, fee, toll, and/or token.

A third party may request various levels of authentication of information that may comprise a fee structure according to the level of detail. A third party could require: a surface match with regards to a social security reference that matches with address, a history match with regards the purchases and debts, a more extensive background check that cross-checks personal accounts with biographic details, or an exhaustive probe that exposits the results of a thorough examination of all of a consumer's personal and financial records. As such, the data record for a consumer may moreover comprise data for and/or access to public and private records that comprise financial attributes such as credit report, tax transcripts, court records, medical records, and/or any type of record that refers to, depends upon, references, or is linked to the identity of a person and/or entity. A third-party may also cause to have data transmitted to, with, preceding, or following an authentication request.

The practice of and service to the authentication of identity may be provided through computer or digital systems. Interfaces to the processor for a consumer may be an internet website, wireless connectivity, automated programming interface (API), automated clearninghouse, batch processes, secure sockets, direct coding, and/or software calls. The consumer may input data through a human-memory interface that is assisted through a node, terminal, website, and/or computer interface. The interface may include physical components that are transported or shipped to and from the consumer.

A physical interface may include a solidstate memory device that may be accessible only one time, a limited number of times, or unlimited number of times in order to record personal data of the consumer. Personal data may include social security numbers, account numbers, biometric data, and/or biographical information. A physical-digital interface may be provide to the consumer in order to input this data in an alphanumeric, digital, audio, electromagnetic, and/or frequentive input. The interface may be sent to and received from the consumer. The data from an interface may be recorded onto, into, through, and/or coded in a data memory record. The data record is accessible directly or indirectly to the processor. The memory device may comprise a processor that interfaces with the authentication request processor, or may be accessed through another processor that interprets between processors.

A data memory device may be inaccessible to a signal or caused to be inaccessible to an electronic signal. The processor that accesses a data memory device may be inaccessible to an electronic signal or caused to be inaccessible to an electronic signal. The processor that retrieves data from a data memory device may comprise a probe or sensor that transmits and/or receives a signal in an optical, wavelength, electromagnetic, molecular compound, combinatorial, thermal, and/or structural format. The data device receives and/or transmits a data signal in an optical, wavelength, electromagnetic, molecular compound, combinatorial, thermal, and/or structural format.

The memory device and/or the processor may receive an electronic signal and subsequently be rendered inaccessible to electronic signals. The memory device and/or the processor may receive an electronic signal and subsequently be rendered inaccessible to electronic signals. The memory device may be rendered inaccessible in order to protect the data from electronic reading and/or writing. The memory device may undergo transformation of physical, chemical, structural, crystallographic, electric, thermal, and/or phase states. Data may be stored, written, encoded, and/or incorporated in or with a physical, chemical, structural, crystallographic, electric, electronic, optical, thermal, and/or phase states of matter. The memory device and/or the processor may have been rendered inaccessible to electronic signals and rendered accessible. A device or processor may be rendered accessible or inaccessible through a physical, electromagnetic, interference, and/or thermal device or apparatus such as a shield or scrambler. A device or processor may be rendered accessible or inaccessible through a timing device, sensor, probe, radiation, thermal, and/or chemical sequence or combination of exposures.

The memory device communicates a signal to the processor with one or more of the methods accessible and/or transformational states. The memory device and processor may also communicate in electronic formats through cifer, interpreter, key, quanta, piranha, rubrix, shibboleth, signals, sublimate, tokens, and/or encrypted data. The processor may read, sense, determine, or register that a signal or state of the memory device. The memory device and processor may be programmed with rules regarding the accessibility of the data and/or device. Accessibility, signals, state, and/or rules are implemented in order to protect the integrity and security of the data. A routine or sequence of one or more of these signals, states, and/or rules may be programmed, calculated, determined, and/or handled in order to grant an access accessibility for the processor to retrieve data. Data is communicated in one or more of these methods to and from one or more memory devices and processors.

In order to authenticate the consumer data, a processor retrieves data from the memory device and receives consumer data from the authentication request. One or more processors conduct the operation of authenticating the consumer data. The processor responds with a determinate signal or status of the consumer identity. The processor may also respond in one or more of the confirmation or complex responses as defined above. The processor that retrieves data from the memory device may be a transmission chip or simple query device that responds with data in a format for a processor performing the authentication check. Separating the function of processors into low-level operations and data storage protects the integrity and security of consumer data. Implementing memory devices that respond in non-electronic ways provides degrees of separation that protect and secure data. The practice of performing authentication of consumer data using the memory devices that are accessible in non-electronic ways further protects the integrity and security of consumer data.

One preferred embodiment of the method protecting and securing data is the protection of credit card information during transactions. The data for financial transactions, for example, is moved from customer to business to credit card company to business to business transactions. With the use of the reference number, customers can be provided with new purchase and sales cards that allow the use of remote b2b transactions in order to process credit card purchase. Merchants and sellers would not need to store credit card information in order to process transactions. One or more reference numbers of the customers, in static and/or dynamic format, would allow a purchase card to process at a point of sale system and supply the needed information to approve a transaction without transmitting a credit card number from the point of sale device. A smartphone or electronic device with selectable accounts also may be used at a point of sale device. Rather, with the one or more reference numbers the purchase card provides the data that the point of sale device uses to process a transaction with a system having a processor that processes the transaction with a credit card company on behalf of the customer.

In the embodiment having the one or more reference numbers and a credit card. Processing of a transaction may proceed first with the method of authenticating identity as described above. Processing a transaction may proceed without a response for authenticating identity or with a multi-valent response as described above. In a portion of a data memory device, credit card numbers may be stored. The customer may have provided these numbers through a graphical user interface or a device that allows for inputting of account numbers. The consumer may select accounts for use with a purchase and/or at a point of sale. The consumer may use one card for purchase while drafting from one or more payment debit, credit, money, derivative, resource buffer, future, pool, donation, and/or bank accounts.

The consumer may also provide settings that automate the selection of one or more credit card accounts in order to process one or more transactions. Previous settings on the priority or preferential use of credit card accounts allows customers to preselect cards for specific uses, such as for food, groceries, fuel, utilities, exchanges, marketplaces, and/or bets. Selection of an account may activate the purchase card for use and/or configure a chip or stripe for use at a point of sale device. The purchase card may be a Smart Card that is programmable by the consumer or a third-party for use at a POS. The consumer can trace and track the details regarding third party requests for financial services such as with the time of request and type of financial service conducted. One or more reports or statements may generate or caused to be generated through any one or more contact, inquiry, request, transaction, notification, authorization, purchase, and/or sale. One or more consumers, entities, networks, systems, commissions, agencies, registers, logs, inquiries, officials, bots, persons, and/or transcripts receive/access to track and/or trace the one or more systems and/or practice that implement one or more financial services.

A purchase card may work on and/or with existing merchant accounts, automated clearinghouse, debit, automated teller machine, and/or credit card transaction systems. Arrangements and configurations may be used to transact purchases automatically and/or automated. Purchases may be initiated and/or transacted by or on behalf of one or more consumers and/or entities. Similarly sales may be conducted using a system as in a sales card rather than a purchase card. As such families may apportion budgetary monies towards accounts that are accessible by one or more persons. Business entities may provide a purchase and/or sales card in order to acquire and/or purchase of materials, goods, services, contracts, transactions, and/or exchanges. Consumers and/or entities may joint accounts with access to shared resources. An entity may cause one or more purchase and/or sales actions to occur and/or operate.

The arrangement of accounts, purchases, and/or sales may be done automatically, with triggers, timing, ranges, thresholds, notification, authorization, or any consumer or supplier control. The customer may also, or alternatively, use a programmable purchase card or purchase device that transmits with a reference number a code or selection of an account to use. A purchase card or device may comprise a chip, display, buttons, indicia, touch-screen and/or touch-sensitive areas that make selections at the time of purchase, at other desired times at the point of sale device, and/or by the customer. Similarly, the point of sale device may also be equipped with such features in order to process customer accounts and/or to process coupons and/or incentives of the retailer or seller. These selections at the point of sale device may be supplied at the time of sale in order to adjust prices. The use of a preferred embodiment of the system allows one or more consumers and/or entities to arrange and configure a customizable system/s and/or infrastructure/s to conduct purchases and/or sales according to private means that are undetectable in public networks. Portions of a system may or may not contain private, personal, financial, and/or identity information on a public network, internet, intranet, extranet, and/or cloud.

A preferred embodiment serves financial decisions according to customer information and third-party data. Processing of a transaction may proceed first with the method of authenticating identity as described above. Processing a transaction may proceed without a response for authenticating identity or with a multi-valent response as described above. A third-party defines a procedure for making financial decisions that comprise one or more rules, programs, regulations, computations, formulas, criterions, and/or evaluations needed to respond to a request for and/or inquiry into a financial service such as auction, barter, credit, derivative, exchange, future, hedge, loan, purchase, refinance, increment, stock, bond, trade, grant, distribution, approval, conditional, request, substitution, transfer, liability, debt, collection, and/or sale of a monetary value. A system may be implemented in order to extend, expand, retract, cancel, and/or recall one or more financial services. Any entity that uses financial services may implement the process of rendering financial decisions. A purchase, sales, service, and/or transaction system may be implemented as a substitute to, competitive with, to supplement, advantageously position, to price, and/or perform auxiliary functions with one or more existing financial systems, exchanges, marketplaces, and/or networks. One or more procedures from one or more entities may be implemented to render one or more financial decisions for one or more customers and/or entities.

The entities may be actuarial, banking, government, revenue, insurance, medical, manufacturers, exchanges, marketplaces, consumer goods, and/or service companies or organizations that use or reference a Social Security Number and/or Employer Identification Number. The third-party requests the reference number of a customer and additional identifying features such as address and telephone number as defined above. The identifying information of the customer may be used to authenticate identity of a customer, entity, and/or a third-party. This request may be through a paper form, digital format, graphical interface, website, automated programming interface, audial format, keypad, telephonic format, and/or electronic input. Similarly the entity may define a procedure through one or more request formats for inputting a procedure. The procedure may translated into one or more program, script, interface, language, code, symbol, and encrypted formats. The procedure may be sent with requests or may be requested from another entity, customer, processor, and/or data memory. Procedures may be run in one or more automated form, batch, clearinghouse, register, and/or shell.

A processor retrieves a third-party procedure and a processor retrieves customer information. A processor processes the customer information according to the third-party procedure. The third-party procedure is implemented to apply custom defined logic to the data of the customer. The processor responds to the request for verification for financial attributes to the third-party. Specific financial data and/or identifying data may, or may not, be provided in the response from a processor to a third-party. The customer may or may not be notified of the request. The customer may or may not be prompted to grant permission to access identity and/or financial data. The customer may or may not have set financial data in a data memory record similar to the identifying information as discussed above. The customer may or may not be prompted about a conditional response that may or may not require permission about a decision of a third-party procedure. The customer may or may not receive information about further actions to obtain a financial product from one or more third-parties. The customer may or may not receive advertisements from third-parties. Customer data and response may or may not be forwarded to one or more third-parties such as a financial services entity or marketplace. A customer, third-party, or entity processing the authentication and/or request may receive incentive, compensation, reward, credit, or commission for processing and/or completing a request.

The third-party procedure may be defined by the third-party, on behalf of a third-party, or for a third party. A procedure may be defined by one or more procedures from one or more individuals, entities, organizations, and/or groups. A procedure defines a set of logical conditions comprising one or more rules, definitions, programs, regulations, computations, formulas, criterions, and/or evaluations needed to respond to a request for and/or inquiry into a financial service such as auction, barter, credit, derivative, exchange, future, hedge, loan, purchase, refinance, increment, stock, bond, trade, grant, distribution, approval, conditional, request, substitution, transfer, and/or sale of a monetary value. The procedure may be used to mask a financial service. The procedure may be used to conceal information about a customer and/or third-party from transmission relating to a financial service. A processor completes a procedure that may or may not result in a response. A processor completes a procedure that may or may not result a read, write, or update of data memory. The procedure may require additional steps or sequences, request information, exchange data, or obtain procedures in order to complete a request. The processor or procedure may respond with a multi-valent response. A multi-valent response may accompany an authentication of identity. A multi-valent response may further include one or more indication, condition, request for more information, time-sensitive response, offer, purchase, sale, instruction, recommendation, denial, transcript, title, lien, deed, bill, record, receipt, or statement.

A procedure defines a set of logical conditions that establish a way to evaluate a procedure or request. As genera, the procedure refers to identification and/or financial data, wherein a procedure requests at least one of these types of data in order to respond to a request. One of the purposes of the procedure is to define a procedure for the criterion to authenticate identity. For example, identity in a form may need to be authenticated according to a time, location, probability, and/or likelihood. Identity may also need to be authenticated using financial data such as tax records, credit card transactions, purchases, sales, and other kinds of transactions that indicate the time and location of a person. A procedure that authenticates identity furthermore responds with one or more responses that may or may not be in a multi-valent format. Procedures may be defined in a manner that is generic for computational and/or human methods of authenticating information depending on the level of sensitivity of the person and/or information. An automated system that operates the services may define procedures that third-parties may use. One or more procedures could define governmental regulations for conducting actuary, business, commerce, pricing, exchanges, transactions, transfers, purchases, sales, tax revenue, tariffs, risk, and/or loans. Or third-parties may define procedures that the service uses to provide customized authentication and/or responses. Procedures may be programmed with one or more flowcharts, process diagrams, scripts, programs, executables, tags, codes, languages, assembly, in-chip, and/or on-chip implements. The procedure may be defined as a software program or in hardware circuits. A procedure may be performed by a processor in one or more local, distributed, remote, cloud, or server computers.

For financial services, the procedure encodes the logic used to determine financial decisions. A procedure automates the process of making financial decisions or decisions that use financial data. A customer application for a loan in one example of the procedure for authentication and response. A loan form routinely includes personal information including name and contact information. The form, however, may include an identifying number or reference for the customer that a procedure uses to authenticate the identity of the customer. Another procedure could operate to obtain the financial information of the customer. A procedure could respond with a query to the customer to supply current income, debt, and address. The procedure could automatically obtain this data from information provided by the customer. Another procedure could obtain the credit score and report on behalf of the customer and store the data in a memory device. Another procedure operates to process the financial information according to the evaluation process of the loan application. Procedures may automate any financial transaction wherein data may or may not be transmitted between a third party and services system. Procedures may be used to record information and/or to respond with business decisions.

A data input device allows a consumer to input identity information into one or more memory storage devices. Consumer inputs information, 100, through an input device such as a keyboard or keypad. A portion of the data, 110, is stored on a networked cloud, 120, and another portion on a memory device, 140. The memory device may be inaccessible to another electronic device after storing the data. A consumer may update and/or modify information through an interface to the memory device or to a memory record in a remote location for processor procedures.

Data is accessed from a memory device, 200, with a memory process having connectivity to processors and a cloud, 240. Data from a set of memory devices, 220, is retrieved by a memory processor, 200. The memory devices operate with an accompanying sensor, 210, or supply device that responds to a request from the memory device to supply identifying data. The perforated lines represent accessible or inaccessible connectivity through an electronic signal. The memory processor sends an interrogative signal to the sensor to obtain data from the memory device. The memory processor provides data to one or more processors, 230, to authenticate the data or retrieve identifying data and/or financial attributes. The personal data is available only to the processors and for a certain amount of time. Personal data may not be stored on a processor or accessible to the cloud. The processor responds through a cloud interface to a request.

A flowchart for secure authentication of identifying data. A request for authentication accompanies personal identifying information, 300. A request processor optionally uses the identifying information to notify a customer of a request for authentication. The dotted lines represent optional sequence or process flow. Notification may be sent through a sms text, email alert, telephonic interface, and/or automated preselected response. The request processor forwards the identifying information to a data processor. The customer responds to the notification of the request for authentication. The data processor obtains identifying number, 310, from the memory device if the customer approves the request. The data processor otherwise forwards the customer response to the authentication processor. The authentication processor authenticates the personal data from the memory device and the identifying data that accompanies the request for authentication, 300, if the customer approves the request. The authentication response, 320, provides the results of the authentication processor according to the identifying information provided in the request and the customer response to authentication notification.

A flowchart for secure authentication of identifying data and response to financial attribute service request. A request for authentication accompanies personal identifying information, 400, and a selection for a procedure to process financial attribute data, 410. A request for financial service may be initiated with a form interface (FIG. 7A). A request processor optionally uses the identifying information to notify a customer of a request for authentication. The dotted lines represent optional sequence or process flow. Notification may be sent through a sms text, email alert, telephonic interface, and/or automated preselected response. The request processor forwards the identifying information to a data processor. The customer responds to the notification of the request for authentication. The data processor obtains identifying data and financial attributes, 420, from the memory device if the customer approves the request. The memory processor obtains the Social Security Number and using the identifying information obtains an identification number from the memory device. The memory processor obtains a financial attribute such as income level. The data processor otherwise forwards the customer response to the authentication processor. The authentication processor authenticates the personal data from the memory device and the identifying data, 400, and financial attributes, 420, if the customer approves the request. The authentication processor forwards the results of the authentication to the procedure processor.

The authentication response, 420, forwards the results and the procedure selection, 410, to the procedure processor. The procedure processor obtains the selected procedure logic, 430. The procedure processor processes the financial attributes, 420, according to the logic of the procedure, 430. Auxiliary processes may be used to obtain additional data or service, either remote or local, through a network or software. Additional data may be a supplemental information required to process the financial service. Additional service may be a request for Credit Report from a Credit Bureau. The procedure processor responds with an authentication response, 440, and a multi-valent response, 450. The multi-valent response comprises an approval and a loan amount. The procedure processor provides the results of the authentication processor according to the identifying information provided in the request, the customer response to authentication notification, the identifying data, and the financial attributes.

A flowchart for a financial service request from a consumer at a Point of Sale. A flowchart for requesting a financial service at a POS. A request for authentication accompanies personal identifying information, 500, and a selection for an account from a purchase card to process purchase request, 510 (FIG. 6). The consumer presets the accounts for selection through an input device and data input interface with connectivity to a cloud data record (FIGS. 1, 2). A digital shopping cart, or store register, provides the currency amount to be purchased, 560, such as the amount in USD. A request processor optionally uses the identifying information to notify a customer of a request for authentication. The dotted lines represent optional sequence or process flow. Notification may be sent through a sms text, email alert, telephonic interface, and/or automated preselected response. The request processor forwards the identifying information to a data processor. The customer responds to the notification of the request for authentication. The data processor obtains identifying data and account number, 520, from the memory device if the customer approves the request. The data processor otherwise forwards the customer response to the authentication processor. The memory processor using the account selection obtains a credit card account number from a cloud memory and using the identifying information obtains an identification number from the memory device (FIG. 2). The authentication processor authenticates the consumer data from the memory device and the identifying data, 500, and identification number and account number, 520, if the customer approves the request. The authentication processor forwards the results of the authentication to the procedure processor.

The authentication processor, 520, forwards the results and the account selection, 510, to the procedure processor. The procedure processor obtains the selected procedure logic, 530. The procedure processor processes a financial transaction with the account number, 520, according to the logic of the procedure, 530, and purchase amount, 560 through a credit card network with connectivity through the auxiliary transactions. The procedure processor responds with an authentication response, 540, and a multi-valent response, 550. The multi-valent response comprises a transaction number and timestamp. The procedure processor provides the results of the authentication processor as a multi-valent response according to the identifying information, the identification number, the customer response to authentication notification, the account selection, and the purchase amount.

A consumer purchase card, 600, having selectable features, 620. The purchase card may be used at a point of sale device and processes the purchase through a procedure. The purchase card initiates the financial services request and sends identifying information to a request processor (FIG. 5). The consumer may select a financial account from the purchase card, 620. The account selection sets the microchip to provide the account selection and is programmed through the electronic connectivity, 630, from the selectable features, 620, to the microchip, 610. The purchase card is inserted into a Point of Sale system that reads the microchip, 610. The request for financial service of a purchase is transmitted to a request processor. The account is sent with the request along with the identifying information. A purchase transaction using a credit card account is processed through the procedure processor. The request receives a multi-valent response of authentication and completion of purchase transaction.

Financial services application form with and without a SSN. A form for financial services includes identifying information of a consumer. A form requests information with an identifying number that authenticates without a Social Security Number, 700. The Social Security Number is stored in a memory device and retrievable through a memory processor (FIGS. 1, 2, 4). A request for authentication and financial service such as a loan is processed without the consumer providing the Social Security Number on a form interface. A prior art form interface requires the consumer to provide the Social Security Number in order to process a request for financial service.

### Definitions

Affect is an analytical state of being of a human, that can be described as an emotion, feeling, experience, behavior, sense, sentiment, intuition, gut-feeling, and any related state that is determined by an internal state. Scheler. Formalism in Ethics and Non-Formal Ethics of Values. Northwestern University Press, 1973. See also the original German Texts. Scheler is useful as an example of affective ways that may be implemented in order to resolve relations among actions and feelings. The references are incorporated by reference in their entirety.

Address. An address refers to one or more mailing address, telephonic telephone number, IP address, domain name, account, number, user login, email address, and/or any way of refer to a location or presence of a person, individual, group, and/or entity. An address may be static, dynamic, referential, sequential, or combinations thereof.

Aggregate Standards are metrics calculated according to demographics, statistics, averages, census, groups, categories, analytics, and the like. These may be public or private data sets that allow the Unique Pricing Engine to hone the price of a product or service for a customer as well as to finance one or more resource buffers.

An anonymity identifier. An identifier that may be used when assigning a number when referring to a person, individual, group, and/or entity for the purposes of statistical, medical, informational, governmental, or organizational purposes.

Entities are any legal entity having formed such as an incorporation, limited liability company, limited liability partnership, joint venture, corporation, and proprietorship, as well as foreign corporations and governmental agencies acting on the behalf of a state, people, or on behalf of corporations.

A financial service. An auction, barter, credit, derivative, exchange, future, hedge, loan, purchase, refinance, increment, stock, bond, trade, grant, distribution, approval, conditional, request, substitution, transfer, and/or sale or a monetary value. Any manner, procedure, means, instrument, or process involving any action of, for, by and/or on behalf of a monetary value. Monetary value may be a currency, credit, metal, note, and/or any form of referring to some-thing of value.

Identifying Number. A number that refers to, points to, references, calls, symbolizes, signifies, and/or gives an address a person, individual, group, and/or entity. Examples of identifying numbers include Social Security Number, Employer Identity Number, driver's license, a customer number, a medical ID number, a serial number, a bar-code, and/or an anonymity identifier.

Individuals are defined as a person. The Unique Pricing Engine provides a price that is unique for a particular person. Non-unique prices may be referred to as customized, personalized, tailored, optimized, intelligent, group, sales, markup, markdown, adjusted, discounted, dynamic, category, class, table, or prioritized pricing.

Local Standards are rates calculated by the U.S. Internal Revenue Service. Other cost of living metrics may be included, as well as metrics that are more finely attuned to the cost of living in localities.

A multi-valent response. Data that signifies one or more modes of information, such as a decision and a confirmation number. Modes of information include gradients, scales, litmus, advisory, alert, caution, signs, symbols, signals, colors, wavelengths, frequencies, and any manner of encoding information. One or more types or forms of data may accompany, associate, follow, precede, refer to, sequence, and/or transmit with one or more modes of communication within any duration or span of time.

A number may be an alphanumeric, cardinal, ordinal, decimal, quantum state, and/or fractional number, and combinations thereof.

Per Diems are rates calculated by the U.S. General Services Administration. Other per diem rates may be included, as well as metrics that are attuned to the cost of visiting localities.

Provider a manufacturer, merchant, wholesaler, producer, retailer, seller, supplier, and/or service provider. A provider may be a person and/or an entity. POS. Point of Sale Device.

Resource Buffer is a monetizable fund that may be used to supplement the price of a product or service. One or more resource buffers may be implemented in generating a unique price for a customer. A resource buffer may be internal to an organization or accessible from a third party.

A third-party may retain anonymity, remain anonymous, or be publicly known. An anonymous third-party could be, i.e., a bank advertising credit card offers to customers. A known third-party could be an insurance company processing an application form of a customer in order to obtain health insurance.

Unique refers the a price that is generated for a specific person or entity. The numeric price may also be unique in that no two persons have the same price for a given product. A unique price may also encompass a fractional price that when modded or rounded appears to be similar or identical to a price offered to another customer.

Value is a numerical state, including and not limited to one or more of a number, integer, decimal, fraction, imaginary number, coordinate space, visual representation, ocular representation, bit, qubit, byte, and any ordinal, cardinal, real, imaginary, geometric, coordinate, affective, set, and representation of a quantity or comparison there-of and -from. Value is an essence state, including and not limited to a property of a thing. As a balloon has essence of a dirigible, so does a statue have essence from its stone. Hintikka. Knowledge and Belief. Reprint 2005. King's College Publications. Hintikka is useful as an example of logic systems that may be implemented in order to resolve undefined relations among terms of knowledge and belief. The references are incorporated by reference in their entirety.

Volumetric cost derivatives, quantified metrics that represent costs of production, manufacturing, shipping, supplying, sales, transaction, clicks, marketing, service, and any cost of good sold. These metrics may be in common to producers of a product, such as the cost of importing or of purchasing raw materials. The actions performed these producers may be provided by a third party servicer who provides the services at a competitive advantage. The ability of the third party servicer to forecast the future expenses of providing services to producers allows volumetric cost derivatives to be leveraged for price competitiveness. The following references are incorporated by reference.

Hintikka. Knowledge and Belief. Reprint 2005. King's College Publications. Hintikka is useful as an example of logic systems that may be implemented in order to resolve undefined relations among terms of knowledge and belief: incorporated by reference in its entirety.

Scheler. Formalism in Ethics and Non-Formal Ethics of Values. Northwestern University Press, 1973. See also the original German Texts. Scheler is useful as an example of affective ways that may be implemented in order to resolve relations among actions and feelings. The references are incorporated by reference in their entirety.

When introducing elements of the examples disclosed herein, the articles “a,” “an,” “the” and “said” are intended to mean that there are one or more of the elements. The terms “comprising,” “including” and “having” are intended to be open-ended and mean that there may be additional elements other than the listed elements. It will be recognized by the person of ordinary skill in the art, given the benefit of this disclosure, that various components of the examples can be interchanged or substituted with various components in other examples.

Although certain aspects, examples and embodiments have been described above, it will be recognized by the person of ordinary skill in the art, given the benefit of this disclosure, that additions, substitutions, modifications, and alterations of the disclosed illustrative aspects, examples and embodiments are possible.

1. (canceled)

2. (canceled)

3. (canceled)

4. (canceled)

5. (canceled)

6. (canceled)

7. (canceled)

8. (canceled)

9. (canceled)

10. (canceled)

11. A computer-implemented method of paying for goods or services, comprising:
Adding articles to a purchase cart or checkout register;
Summing the articles for purchase;
Transmitting identification numbers that correspond to products to a pricing engine;
Transmitting purchase prices for said products to a pricing engine;
Transmitting an identification number that corresponds with a point of purchase device of a customer;
Receiving a unique price for each of a plurality of articles for purchase, wherein each unique price is adjusted from the store price and the unique prices are displayed to the customer; and
Paying for the articles with a point of purchase device;
Receiving a receipt for articles purchased;
Paying a statement balance based on the one or more adjusted prices.

12. The method of claim 11, wherein the display of a unique price is adjusted based on price credits for a personal affect, personal attribute, and a personal belief.

13. The method of claim 11, wherein the unique price calculated according to price credits for a personal affect, personal attribute, and personal belief.

14. The method of claim 11, wherein said point of purchase device uses a personal electronic address that comprises at least a partial electronic payment wherein said address and further comprises indicia for a personal attribute and either a personal affect or a personal belief.

15. The method of claim 11, wherein a price adjustment is determined according to at least one electronic attribute address and at least one partial electronic payments wherein said address and payment are debited from one or more accounts that each correspond with a personal affect, personal address, or a personal belief.

16. The method of claim 11, wherein a point of purchase device further comprises an electronic digest of personal affects and personal attributes wherein an electronic device compiles prices for a customer according to a plurality of electronic addresses and personal attributes.

17. The method of claim 11, wherein said paying for articles comprises a bundled electronic payment wherein two or more payment amounts are processed at or near an instance of a single payment transaction.

18. The method of claim 11, wherein price adjustments are calculated using a value attribute state that is calculated from a plurality of personal affects and personal beliefs.

19. The method of claim 11, wherein said point of purchase device accesses or comprises a price clearinghouse comprising calculations of prices wherein a processor calculates credit or debit values with one or more personal electronic addresses that comprise at least a partial payment and wherein a processor determines a display of a plurality of prices to a customer according to one or more personal attributes of said customer.

20. The method of claim 11, wherein said a price for a customer wherein a value of said price floats according to a real-time digest of partial electronic payments and wherein said payments comprise personal attribute addresses.

21. The method of claim 14, further comprising a method of using an attribute address, comprising:
Determining attribute addresses that correspond with personal attributes of a person;
Storing said attribute addresses in a profile that corresponds to said person;
Linking one or more devices of said person to said profile;
Determining that a partial payment is available for said person that corresponds with one or more attribute addresses that correspond to said profile;
Delivering a unique price to said device linked to said profile.

22. The method of claim 11, wherein the register interface comprises displaying an electronic cart of products to a customer that comprises a plurality of unique price for the products that are determined with personal electronic addresses that correspond with an account or index that is determined according to personal affects, attributes, and beliefs.

23. The method of claim 11, wherein the register interface comprises determining a personal affect using an electronic interface that receives input about an action, feeling, or emotion of a person.

24. A computer-implemented method of retrieving a partial payment, comprising:
a first customer electronic selects a combination of attributes and amount of money;
a second customer registering a plurality of personal attributes;
said second customer selects a service for booking at an interface that comprises a price;
a Pricing Engine traversing combinations of attributes;
said Pricing Engine identifies a combination of attributes that match a plurality of personal attributes of said second customer;
said Pricing Engine retrieves an amount of money that corresponds with a combination of attributes;
said Pricing Engine debits an amount of money from an account that corresponds with said combination of attributes;
said Pricing Engine send a new price for a booking to a booking interface, wherein the new price is calculated from the price and amount;
said second customer confirms or pays for said booking.

25. The method of claim 24, further comprising a method of generating a booking interface, comprising:
Registering for a profile;
Registering one or more devices and linking said devices to said profile;
Registering personal attributes of a person;
Transmitting a price to a person or a device that corresponds with an attribute of said person.

26. The method of claim 24, further comprising a method of generating a booking interface, comprising:
Registering for a profile;
Registering one or more devices and linking said devices to said profile;
Registering personal attributes of a person;
Determining an attribute address for a person;
Transmitting a booking interface to a person on a device by an attribute address, wherein the attribute address comprises a price.

27. The method of claim 24, further comprising a method of generating a booking interface, comprising:
Registering for a profile;
Registering one or more devices and linking said devices to said profile;
Registering personal attributes of a person;
Determining a plurality of attribute addresses for a person;
Selecting a record for booking;
With a Pricing Engine, Traversing said attribute addresses for a person;
Retrieving a partial payment from one or more attribute addresses for said booking record;
Determining a price for a booking according to a sum total of partial payments;
Displaying a booking interface for said booking record wherein a price for said booking is determined according to one or more attribute addresses.

28. The method of claim 24, further comprising a method of using an attribute address, comprising:
Determining attribute addresses that correspond with personal attributes of a person;
Storing said attribute addresses in a profile that corresponds to said person;
Linking one or more devices of said person to said profile;
Determining that a partial payment is available for said person that corresponds with one or more attribute addresses that correspond to said profile;
Delivering a unique price to said device linked to said profile.

29. The method of claim 24, wherein the booking interface comprises displaying an electronic schedule of bookable appointments to a customer that comprises a plurality of unique prices for the bookable appointments that are determined with personal electronic addresses that correspond with an account or index that is determined according to personal affects, attributes, and beliefs.

30. The method of claim 24, wherein the booking interface comprises determining a personal affect using an electronic interface that receives input about an action, feeling, or emotion of a person.
